(19) United States
(12) Patent Application Publication
(10) Pub. No.: US 2014/0319432 A1
(43) Pub. Date: Oct. 30, 2014

(54) Wear-Resistant Nanocrystalline Hard Noble Metal Coating

(71) Applicant: Sandia Corporation, Albuquerque, NM (US)

(72) Inventors: Ronald S. Goeke, Albuquerque, NM (US); Nicolas Argibay, Albuquerque, NM (US); Somuri V. Prasad, Albuquerque, NM (US)

(73) Assignee: Sandia Corporation, Albuquerque, NM (US)

(21) Appl. No.: 14/242,746

(22) Filed: Apr. 1, 2014

Related U.S. Application Data
(60) Provisional application No. 61/815,635, filed on Apr. 24, 2013.

(51) Int. Cl. H01B 1/02; H01B 13/00

(52) U.S. Cl. CPC H01B 1/02; H01B 13/003
USPC 252/514; 427/597

(57) ABSTRACT

A new class of electrically conductive, wear resistant, and high thermal stability nanocrystalline noble metal coatings achieved by codeposition of an insoluble, unreactive, and thermally stable, grain boundary segregated ceramic species that strengthens the base metal by inhibiting grain boundary mobility and recrystallization during deposition. These coatings exhibit high hardness and wear resistance while maintaining electrical conductivity effectively equivalent to that of the pure, fine-grained base metal. The coatings exhibit relatively low friction coefficients in nominally unlubricated sliding, and high thermal stability. The friction, wear, and electrical contact characteristics of these coatings are comparable or superior to electroplated hard gold films used extensively in electrical contact applications. The use of physical vapor deposition techniques such as electron beam evaporation provides an environmentally friendly alternative to electroplating for the synthesis of high performance hard gold films.

### CROSS-REFERENCE TO RELATED APPLICATIONS

This application claims the benefit of U.S. Provisional Application No. 61/815,635, filed Apr. 24, 2013, which is incorporated herein by reference.

### STATEMENT OF GOVERNMENT INTEREST

This invention was made with Government support under contract no. DE-AC04-94AL85000 awarded by the U. S. Department of Energy to Sandia Corporation. The Government has certain rights in the invention.

### FIELD OF THE INVENTION

The present invention relates to wear-resistant coatings and, in particular, to wear-resistant nanocrystalline hard noble metal coatings for electrical contacts synthesized by physical vapor deposition.

### BACKGROUND OF THE INVENTION

Hard gold refers to a class of gold-rich alloys exhibiting relatively high hardness and wear resistance while retaining the chemical inertness and electrical conductivity of the parent material. Hard gold coatings are traditionally deposited in thin film form via electrodeposition and consist of an alloy of primarily gold (no less than 0.99 mass fraction of Au) and one or a combination of Co, Ni, and Fe, with minimum thicknesses ranging from 250 nm to 5 μm. See ASTM B488-11. The use of electroplated hard gold is widespread as a coating for switching and sliding electrical contacts and as a bonding and soldering material in a number of semiconductor manufacturing applications. As demonstrated by Lo et al., the principal role of codeposited species as a hardening agent is to mitigate recrystallization and thus achieve a relatively thermally stable fine grain microstructure (Hall-Petch strengthening) by grain boundary pinning. See C. C. Lo et al., J. Appl. Phys. 50, 6887 (1979).

A key limitation of hard gold coatings is the propensity for the non-noble alloying elements (e.g. Ni, Co) to diffuse to the surface and form non-conductive surface films (passivating oxides) adversely impacting the electrical contact behavior. Therefore, significant effort has been devoted to understand the relevant degradation mechanisms and kinetics. See H. G. Tompkins and M. R. Pinnel, J. Appl. Phys. 48, 3144 (1977); H. G. Tompkins and M. R. Pinnel, J. Appl. Phys. 47, 3804 (1976); H. G. Tompkins, J. Electrochem. Soc. 122, 983 (1975); and M. Antler, Plat. Surf. Finish. 85, 85 (1998). Further, conventional electrochemical deposition processes are limited to electrochemically compatible metal hardened gold-rich films (e.g. Au—Ni or Au—Co). Finally, traditional electroplating and electroless plating methods can have negative environmental impact associated with the use of toxic chemicals in plating baths and associated waste disposals.

Therefore, a need remains for alternative deposition techniques for wear resistant hard noble metal coatings.

### BRIEF SUMMARY OF THE INVENTION

The present invention is directed to a wear-resistant, chemically unreactive, high thermal stability, electrically conductive, nanocrystalline hard noble metal coating that can be synthesized via physical vapor deposition and, preferably, electron beam (e-beam) evaporation. The nanocrystalline coating comprises two (or more) codeposited species, wherein nominally pure noble metal is strengthened by reducing its average grain size to below 100 nm (nanocrystalline) by incorporating minute quantities of secondary ceramic phase(s). The secondary ceramic species that are insoluble in the noble metal preferentially reside at grain boundaries (GBs) and thereby produce a reduction in grain size and inhibition of crystallographic texturing by terminating grain growth during deposition and inhibiting grain boundary mobility. Grain size reduction, or Hall-Petch strengthening, is associated with increased hardness and wear resistance. For the purpose of applications requiring high electrical conductivity and wear resistance, the concentration of the secondary ceramic is preferably less than 5 vol. %, a threshold beyond which grain refinement becomes negligible. The tribological performance of nanocrystalline gold coatings, for example, is comparable or superior to electroplated metal-hardened gold coatings. A nominally stable nanocrystalline microstructure in gold may be achieved using a variety of ceramic species, e.g. ZnO, SnO₂, In₂O₃ or TiN. Additionally, these nanocrystalline hard gold coatings retain a gold-hue over a wide range of compositions. Therefore, the coatings are ideally suited where any combination of the following properties are required: (1) wear-resistance, (2) low friction in dry/unlubricated conditions, (3) high thermal stability, (4) high chemical stability, and (5) the need for a gold hue in a hard coating. The wear-resistant, electrically conductive nanocrystalline coatings are especially attractive for electrical contact applications (e.g. AC or DC switches, low current communication slip-rings, and high current transfer systems).

The invention is further directed to a method for synthesizing wear-resistant noble metal coatings, comprised primarily of a noble metal species and a codeposited GB-segregated ceramic species, for example via simultaneous physical vapor deposition of a noble metal and a ceramic from separate sources onto a substrate. The use of e-beam evaporation, a physical vapor deposition (PVD) technique, increases the range of materials beyond those achievable via traditional electrodeposition routes. Synthesis via PVD also circumvents the need for use and disposal of toxic chemicals inherent in electrodeposition of hard gold, and also enables synthesis of codeposited structures using a wide variety of hardener types that are impractical to achieve via electrodeposition.

### BRIEF DESCRIPTION OF THE DRAWINGS

The detailed description will refer to the following drawings, wherein like elements are referred to by like numbers.

FIG. 1 is an electron micrograph and composition map (inset) of a nanocrystalline gold film (with 2 vol. % ZnO) viewed from the surface normal orientation and showing GB segregation of the ceramic species.

FIG. 2 is a photograph of the inside of the e-beam evaporation chamber used for the codeposition of a nanocrystalline Au—ZnO films.

FIG. 3 shows representative electron diffraction grain orientation maps for a pure gold (left panel) and an Au-2.0 vol. % ZnO nanocrystalline film (right panel).

FIG. 4A is a graph of average grain size as a function of ZnO concentration. FIG. 4B is a graph hardness and electrical resistivity as a function of volume and weight percentages of ZnO for 2 μm thick nanocrystalline Au—ZnO films. The typical range of type I and II hardness defined in ASTM B488-11 for electroplated engineering hard gold are shown in FIG. 4B for reference purposes.

FIG. 5 is a graph of electrical resistivity as a function of composition for 2-μm thick Au—ZnO nanocrystalline films, and an inset plot showing hardness and electrical resistivity over the range of compositions most relevant to electrical contacts, below about 5 vol. %.

FIG. 6A is a graph of friction coefficient and electrical contact resistance (ECR) per unidirectional sliding cycles for a film of codeposited Au-2 vol. % ZnO. FIG. 6B is a graph of friction coefficient and ECR per unidirectional sliding cycles for a film of electroplated type I nickel-hardened gold.

FIG. 7A is a topographical map (upper) and average cross-sectional wear track area (lower) for an Au-5 vol. % ZnO film. FIG. 7B is a topographical map (upper) and average cross-sectional wear track area (lower) for an electroplated type I nickel-hardened gold film. FIG. 7C is a plot of multi-point wear measurements and corresponding specific wear rates for these two contact materials.

### DETAILED DESCRIPTION OF THE INVENTION

The present invention is directed to wear-resistant, chemically unreactive, electrically conductive, nanocrystalline hard noble metal films synthesized via physical vapor deposition (PVD) and, preferably, electron beam (e-beam) evaporation. The material comprises two or more codeposited species, wherein a nominally pure noble metal is strengthened by reducing its grain size by the addition of a codeposited ceramic species. The electrically conductive noble metal preferably comprises Au, but can alternatively comprise other noble metals, such as Pd, Ag, or Pt. The secondary species comprises a ceramic deposited in its thermodynamically stable form, and provides a nanocrystalline material that will not undergo phase transitions up to 600K (or at temperatures below about one third of the melting point of the base noble metal). An example of such a nanocrystalline material is e-beam codeposited Au—ZnO. Alternative ceramic materials include other metal oxides and nitrides, such as ZnO, Al₂O₃, In₂O₃, or TiN. The ceramic species is insoluble with the base metal species, and serves the purpose of inhibiting grain boundary mobility and recrystallization.

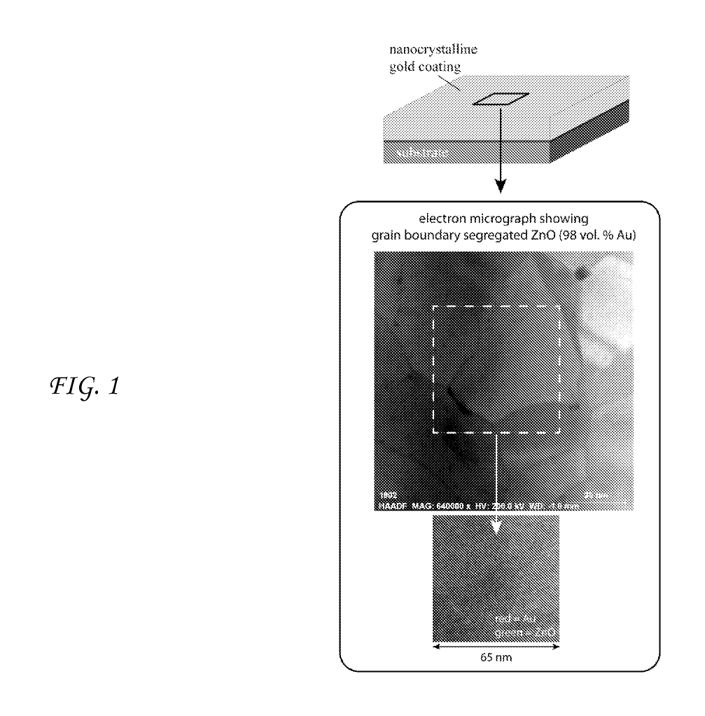

The high hardness and high wear resistance exhibited by this class of nanocrystalline noble metal films relies on Hall-Petch strengthening via grain refinement as the principal hardening mechanism, directly correlated to high wear resistance. The addition of a primarily GB segregated ceramic phase(s) in a base metal film synthesized via PVD can be used to achieve finer grain size, increased hardness, higher wear resistance, and high thermal stability. FIG. 1 shows the segregation of a codeposited ceramic material (ZnO) on the GBs of a nominally gold film (98 vol. %) achieved by co-evaporation. FIG. 3 show representative electron diffraction maps of the film surfaces (surface normal orientation), demonstrating significant reduction in the average grain size and elimination of crystallographic texturing observed in pure e-beam Au films with the addition, in this instance, of 2 vol. % ZnO. Using the e-beam process, the codeposited ceramic phase is well dispersed and segregated to the gold grain boundaries, resulting in progressively greater grain refinement with increased concentration of the ceramic phase associated with increase in hardness, wear resistance, and thermal stability of the gold.

### Electron Beam Evaporation

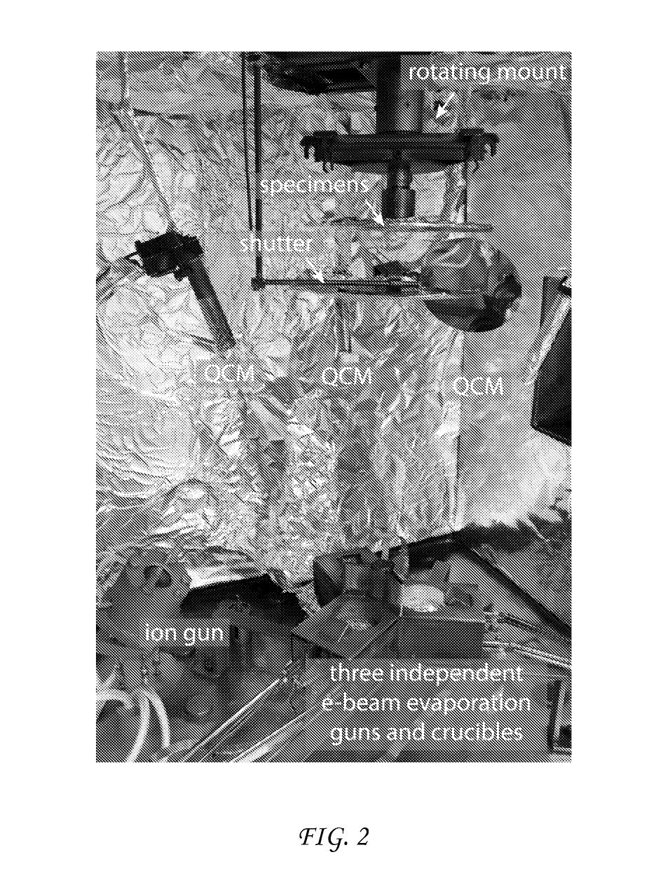

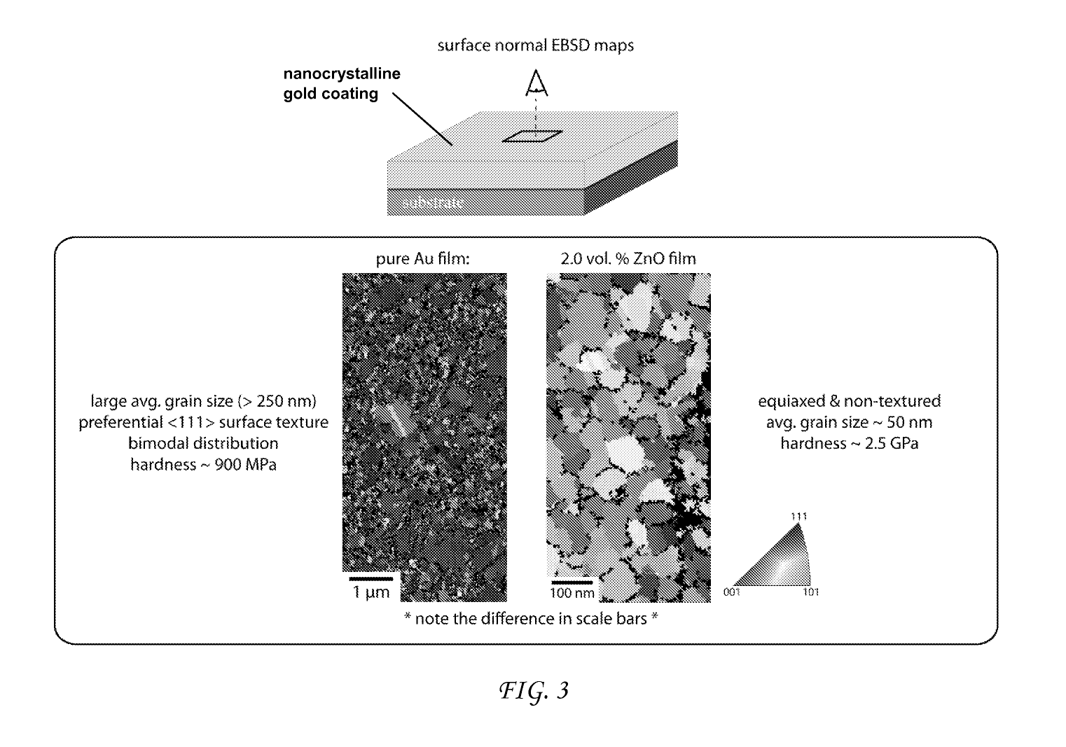

Electron beam (e-beam) evaporation, a form of physical vapor deposition, is conducted in a high vacuum environment in which a pure material source can be vaporized (thermally) and then deposited by condensation on a substrate to provide a pure thin film of the parent material. The codeposition of two or more material sources simultaneously results in a composite or alloy, depending on the constituents. FIG. 2 is a photograph of the inside of a typical e-beam evaporation chamber that can be used for the codeposition of the metal and the secondary ceramic phase material. This chamber is equipped with an ion gun for in situ pre-deposition surface cleaning, three e-beam evaporation guns and source crucibles, quartz crystal microbalances (QCMs) for independent and simultaneous rate controlled codeposition of up to three materials, a motorized shutter for masking the sample part during the startup and shutdown of a deposition run, and a rotating sample mount to improve homogeneity of the deposited material. The high accuracy of QCMs commonly used in e-beam evaporation systems enables practical compositional control below 0.1 vol. %. Uniformity of the codeposited material can be accomplished by sample rotation and/or planetary motion. Further, the composition of the ceramic can be easily graded through the thickness of the coating simply by changing the evaporation rate of the ceramic relative to the metal gradually during the deposition of the coating. Further, layers of different metals and/or ceramics or layers with different compositions thereof can be produced by changing the evaporation source(s) or by changing the relative evaporation rates abruptly during the deposition of the coating. Because the deposition process is conducted in vacuum, only the desired coating materials are used and the process produces no chemical waste, completely circumventing the need to use or dispose of hazardous and ecologically damaging chemicals found in traditional electroplating techniques for deposition of hard gold coatings (e.g. arsenic and cyanide containing baths). Further, modern advances in deposition techniques have made practical and economical large-batch PVD a reality, such as in the fabrication of photovoltaic panels and thin film glazing of architectural glass.

An additional benefit to the use of e-beam evaporation for synthesizing the class of materials described herein is the ability to perform in situ cleaning of the substrate or part to be coated inside the deposition chamber, without the need to expose the part to air (oxidation) and contaminants (such as adventitious carbon) prior to coating the part, as is the case with electrodeposited parts. Techniques such as plasma or ion beam cleaning or sputter etching can be easily incorporated in the deposition process, enabling removal of oxide layers and contaminants (organics and other foreign matter). The degree of cleanliness that can be achieved with in situ cleaning is impractical with electroplating processes. Added cleanliness prior to deposition improves adhesion of the coating to the part or substrate material. The practical thickness of an e-beam evaporated film can exceed 10 μm, and is only limited by the availability of target material and time. For electrical contact applications, the thickness of a noble metal (e.g. hard gold) coating is typically less than 2 μm.

### Example

### Nanocrystalline Au—ZnO Films

As an example of the present invention, a room temperature e-beam codeposited nanocrystalline Au—ZnO film was investigated. The friction, wear, and electrical contact resistance (electrical-tribological) behaviors of e-beam codeposited Au—ZnO films were investigated in detail for compositions in the range 0 to 100 vol. % of ZnO.

Surface electron backscatter diffraction (EBSD) and transmission electron microscopy (TEM) analysis on film surfaces of varying composition were used to quantify the reduction in average grain size with increasing concentration of ZnO. FIG. 3 shows EBSD grain orientation maps viewed from a surface normal orientation for a pure gold (left panel) and a nanocrystalline Au-2.0 vol. % ZnO film (right panel). Both films were 2 μm thick and deposited or codeposited via electron beam evaporation. The EBSD maps reveal a typical highly bimodal and crystallographic textured (<111> orthogonal to the surface) grain distribution for the pure Au film, and a significant reduction in average grain size and crystallographic texturing with the addition of a relatively small amount (2 vol. %) of ZnO. The average grain size for the 2 μm thick pure e-beam deposited Au film was in the 1-10 μm range, and for a Au-2.0 vol. % ZnO film in the range 50-100 nm. The TEM image in FIG. 1 shows the preferential segregation of ZnO at the GBs of the gold film, resulting in a reduction in grain size and providing thermal stability by providing an obstacle to grain boundary mobility.

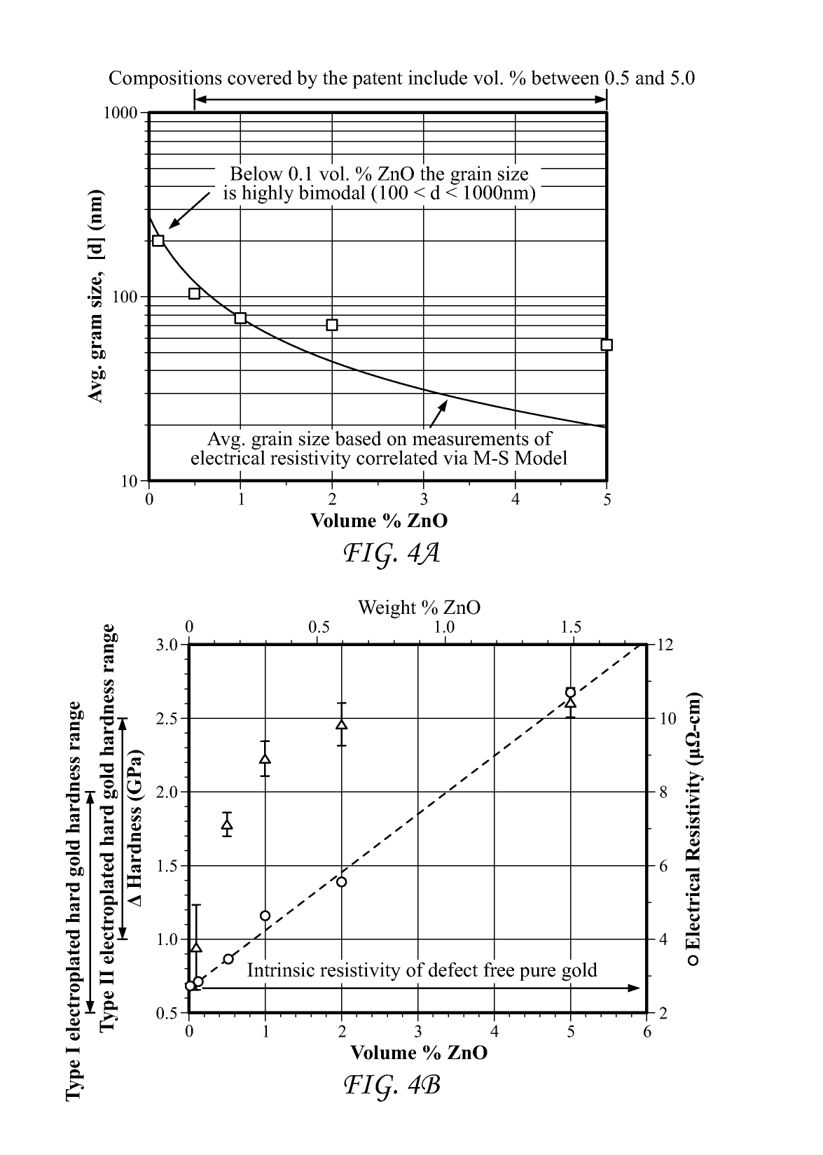

FIG. 4A is a graph showing a correlation between average grain size and composition for Au—ZnO films. It should be noted that the average grain size of e-beam gold with 2 vol. % ZnO reduced well below 100 nm and into the nanocrystalline regime. The transition to average grain size below 100 nm appears to occur at a volume fraction of about 0.5% ZnO. It should also be noted that due to a significantly reduced density of the ceramic phase compared to traditional metal hardener species (e.g. Ni or Co), the range between 0.5 and 2.0 vol. % ZnO corresponds to a range of about 0.1 to 0.6 wt. %, which is approximately the same as the weight percent range suggested for metal hardened gold in ASTM and Milspec specifications. FIG. 4B is a graph showing the corresponding hardness and bulk (sheet) electrical resistivity measured via nanoindentation and the van der Pauw (4 point) method, respectively. The films exhibited a corresponding grain size reduction, correlated to a hardness increase (Hall-Petch strengthening), from about 0.5 GPa for 0.1 vol. % ZnO to greater than 2.5 GPa for >2.0 vol. % ZnO.

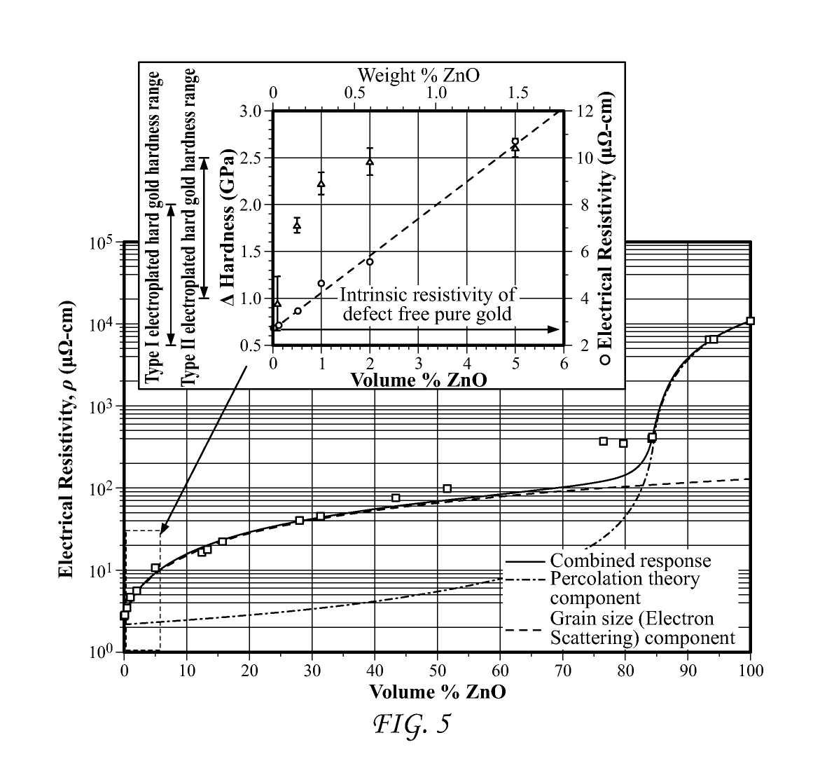

FIG. 5 is a graph of electrical resistivity as a function of composition for 2 μm thick Au—ZnO films, and an inset plot showing hardness and electrical resistivity over the range of compositions. Electrical resistivity measurements of films in the range 0 to 10 vol. % ZnO exhibited a linear increase in resistivity from 2.7 μΩ-cm to 16.5 μΩ-cm, while at higher contents of ZnO the resistivity deviated from linear dependence on concentration, with a resistivity of 39.9 μΩ-cm for 50 vol. % ZnO, and a percolation threshold of 85 vol. % ZnO. It is important to note that the increase in hardness and electrical resistivity that occur in the range 0 to 5 vol. % ZnO are clearly associated with a reduction in grain size and not accurately described by percolation theory, indicating that these materials are not composites in the traditional definition. The hardness is primarily achieved via grain size reduction through GB pinning using ceramic particles, and not via hard particle reinforcement. The increase in electrical resistivity is effectively only attributed to a refinement in grain size, and the propensity for electrons to scatter when encountering defects such as grain boundaries (explained by the Mayadas-Shatzkes model).

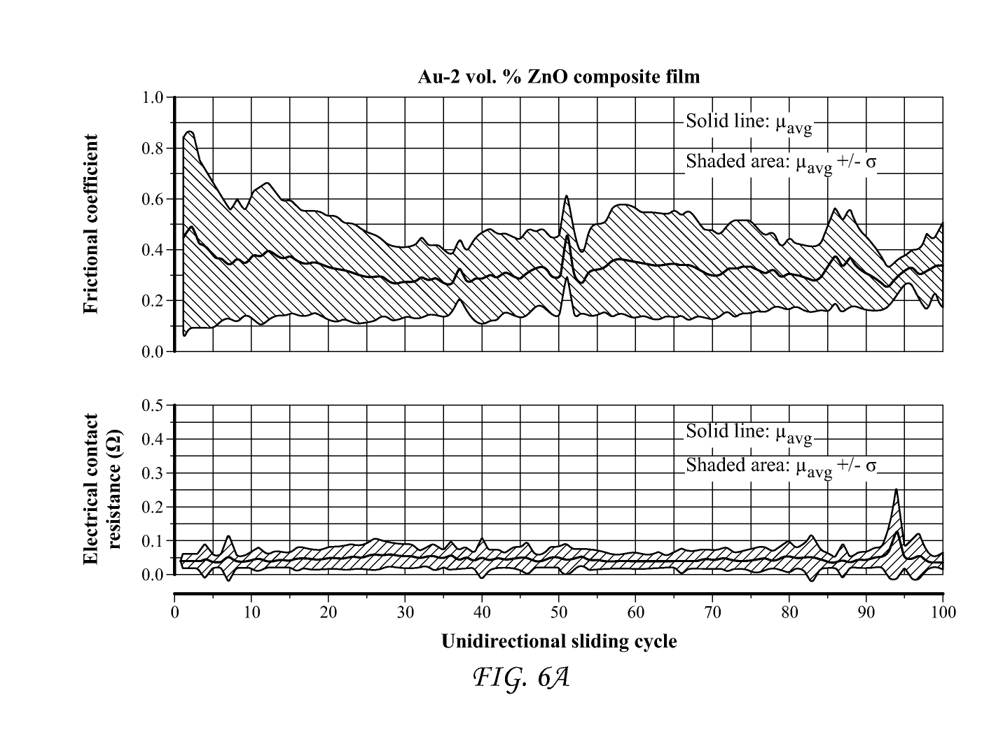

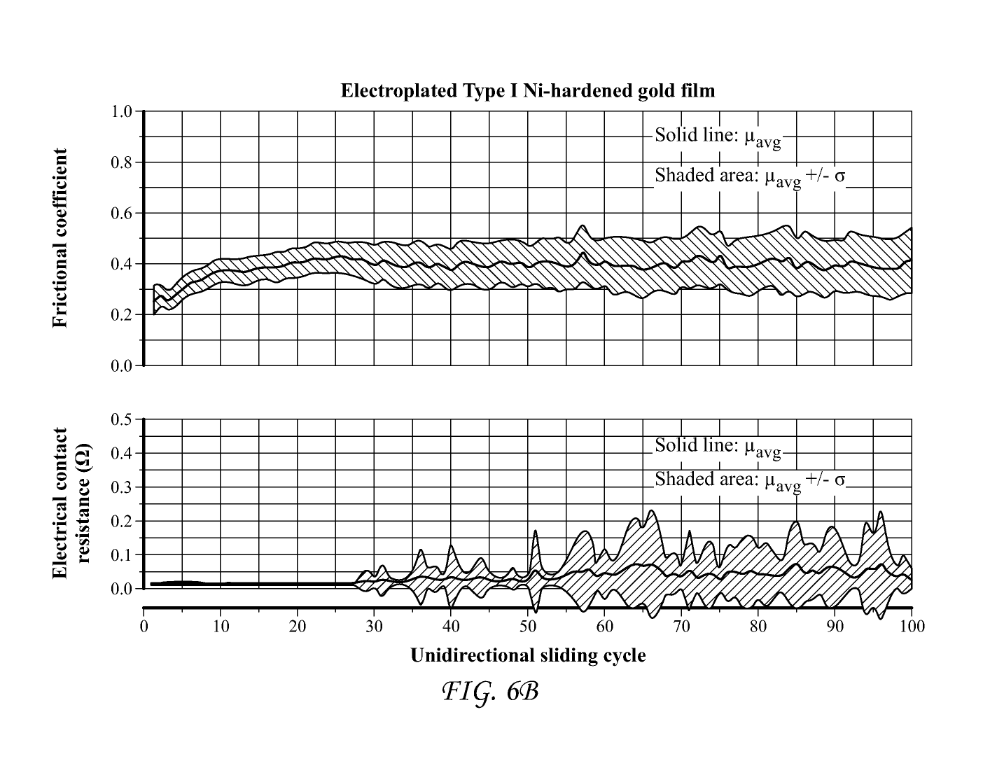

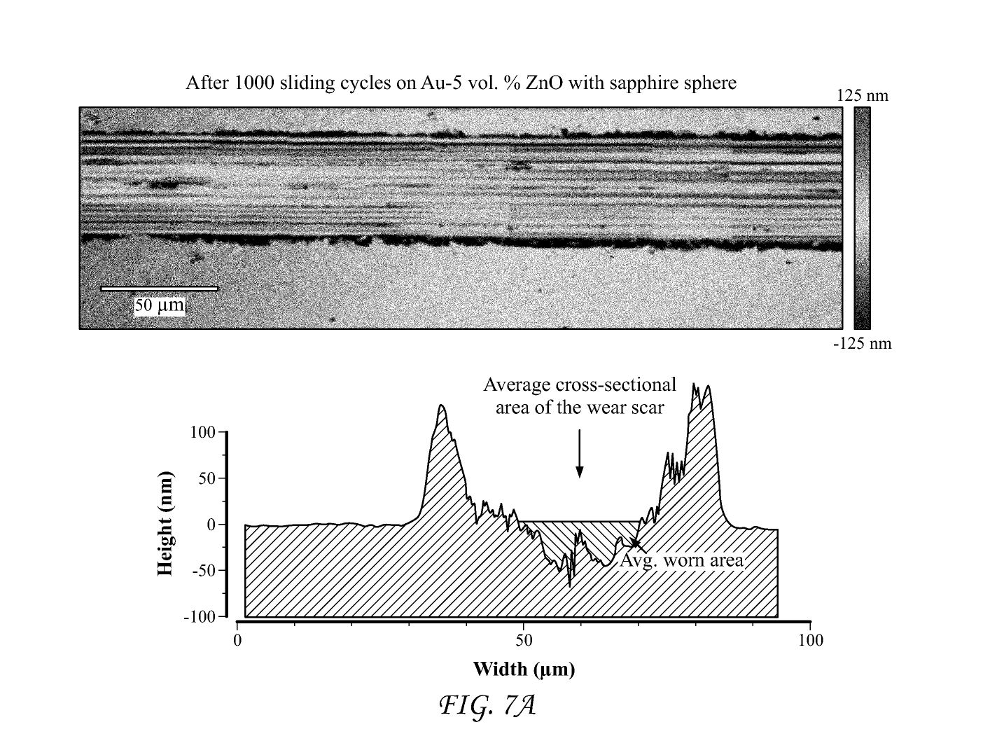

The friction, wear, and electrical contact resistance (ECR) of 2 and 28 vol. % ZnO films sliding against commercially available hardened Au riders (nominally 17 k gold, with composition of 72Au-14Cu-8Pt-5Ag by weight, and hardness of 255 HK) were investigated. FIG. 6A is a graph of friction coefficient and ECR data per unidirectional sliding cycle for a film of e-beam deposited Au-2 vol. % ZnO. FIG. 6B is a similar graph for a film of electroplated type I nickel-hardened gold. Both films were 2 μm thick and deposited on a conductive substrate (50/50 by vol. % Fe—Ni), sliding against a spherically tipped 17 k hardened gold pin with a contact force of 100 mN (maximum Hertzian contact stress of 166 MPa). A 1 mm/s sliding speed was used and experiments were performed in lab air (20° C. and 20% relative humidity). Measured friction coefficient and electrical contact resistance data were in the range μ=0.3 to 0.5 and ECR=40 mΩ and 500-2000 mΩ, respectively. Therefore, the addition of the secondary species results in a reduction in friction coefficient for nominally unlubricated contact against hard gold alloys of μ>1.0 (gross adhesion and transfer of the pure coarse grained gold) to consistent and relatively low friction coefficients of about μ=0.4 for an Au-2 vol. % ZnO film.

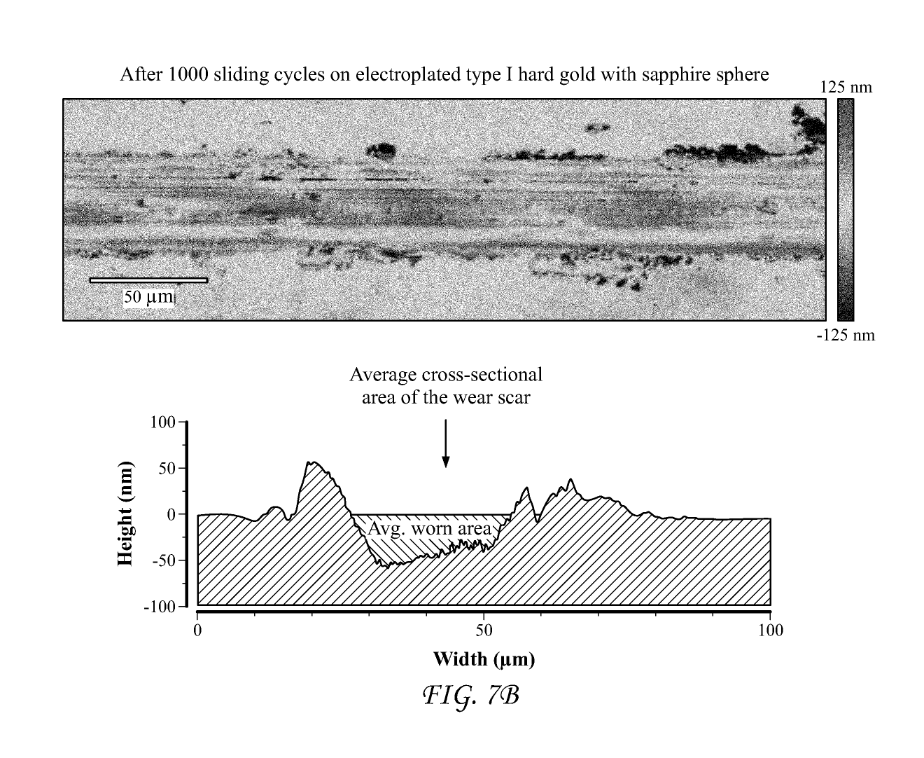

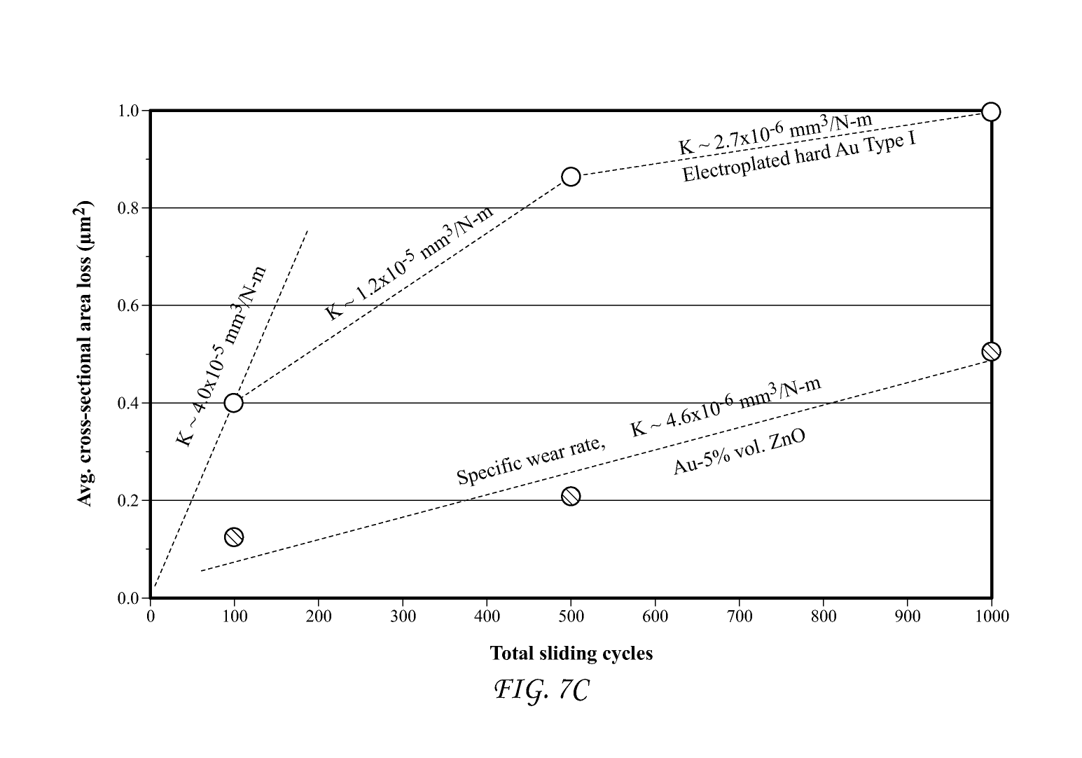

An additional experiment comparing the wear characteristics of a 5 vol. % ZnO film and a commercially acquired electroplated type I Ni-hardened gold film, both with a film thickness of 2 μm and deposited on conductive (50/50 by vol. % Fe—Ni) substrates, was performed against a relatively harder 3.175 mm diameter sapphire ball in nominally unlubricated conditions. FIG. 7A is a topographical map (upper) and a graph of the average cross-sectional wear track area (lower) for an Au-5 vol. % ZnO film. FIG. 7B is a topographical map (upper) and a graph of the average cross-sectional wear track area (lower) for the electroplated type I nickel-hardened gold film. The maps and graphs were after 1,000 cycles of unidirectional sliding against a 3.175 mm diameter polished sapphire sphere using a 100 mN contact force and 1 mm/s sliding speed in lab air. The friction coefficient for both materials was about μ=0.4 over 1,000 cycles of unidirectional sliding, and the specific wear rate of the Au—ZnO composite was K=4.6×10⁻⁶ mm³/N-m, comparable or better than the electroplated gold, in the range 40.0×10⁻⁶ mm³/N-m to 2.7×10⁻⁶ mm³/N-m. FIG. 7C is a plot of multi-point wear measurements and corresponding specific wear rates for these two contact materials. The improvement in specific wear rate by the addition of relatively small amounts of ZnO can be greater than 3 orders of magnitude compared to a pure gold film in sliding against hard alloyed gold.

Investigations of the thermal stability of these materials were performed by heating an Au-2 vol. % ZnO film to 250° C. for 5 days. Grain size was evaluated directly via microscopy (electron diffraction) and did not reveal a noticeable change in the grain size of the films. Similarly, electrical resistivity measurements did not indicate a significant decrease in the bulk (sheet) electrical resistivity of the films due to the anneal, confirming that there was no significant change in the grain size. While it is possible to reduce the grain size in PVD films through process control, by reducing the deposition temperature and rate, the absence of a stabilizing grain boundary segregated dispersed secondary species would negatively impact the thermal stability of the film; in the absence of the stabilizing species the spontaneous and rapid recrystallization of the gold would occur even at room temperature during frictional contact.

The present invention has been described as wear-resistant, electrically conductive ceramic phase dispersion strengthened noble metal nanocrystalline coatings. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A nanocrystalline noble metal coating, comprising:
a noble metal, and
an insoluble, thermodynamically stable secondary ceramic that is co-deposited with the noble metal to provide a coating comprising less than 5 vol. % ceramic.

2. The nanocrystalline noble metal coating of claim 1, wherein the noble metal comprises Au.

3. The nanocrystalline noble metal coating of claim 1, wherein the noble metal comprises Pd, Ag, or Pt.

4. The nanocrystalline noble metal coating of claim 1, wherein the ceramic comprises a metal oxide or metal nitride.

5. The nanocrystalline noble metal coating of claim 4, wherein the ceramic comprises ZnO.

6. The nanocrystalline noble metal coating of claim 4, wherein the ceramic comprises Al₂O₃, In₂O₃, or TiN.

7. The nanocrystalline noble metal coating of claim 1, wherein the noble metal and ceramic are co-deposited by a physical vapor deposition process.

8. The nanocrystalline noble metal coating of claim 7, wherein the physical vapor deposition process comprises e-beam evaporation.

9. The nanocrystalline noble metal coating of claim 1, wherein the coating comprises between 0.1 and 5 vol. % ceramic.

10. The nanocrystalline noble metal coating of claim 1, wherein an average grain size of the coating is less than 100 nm.

11. The nanocrystalline metal coating of claim 1, wherein the composition of the ceramic is graded through the thickness of the coating.

12. The nanocrystalline metal coating of claim 1, wherein the coating comprises at least two layers, wherein each layer comprising a different noble metal or ceramic composition.

13. A method for depositing a nanocrystalline metal coating, comprising:
providing an electron beam evaporation system adapted to deposit at least one noble metal and at least one ceramic simultaneously on a substrate, and
codepositing the at least one noble metal and the at least one ceramic on the substrate, thereby producing a nanocrystalline noble metal coating comprising a noble metal matrix and a grain boundary segregated secondary ceramic and wherein the coating comprises less than 5 vol. % ceramic.

14. The method of claim 13, wherein the at least one noble metal comprises Au, Pd, Ag, or Pt.

15. The method of claim 13, wherein the at least one ceramic comprises a metal oxide or metal nitride.

16. The method of claim 15, wherein the at least one ceramic comprises ZnO, Al₂O₃, In₂O₃, or TiN.

17. The method of claim 13, wherein the nanocrystalline noble metal film comprises between 0.1 and 5 vol. % ceramic.

18. The method of claim 13, further comprising changing the relative rate of deposition of the at least one noble metal and the at least one ceramic during the codepositing, thereby providing a coating wherein the composition of the ceramic is graded through the thickness of the coating.
